(19) United States
(12) Patent Application Publication
(10) Pub. No.: US 2015/0319908 A1
(43) Pub. Date: Nov. 12, 2015

(54) Garden Implement

(71) Applicants: Doreen D. Kuss, Portersville, PA (US); William E. Kuss, Portersville, PA (US)

(72) Inventors: Doreen D. Kuss, Portersville, PA (US); William E. Kuss, Portersville, PA (US)

(21) Appl. No.: 14/275,123

(22) Filed: May 12, 2014

(51) Int. Cl. A01B 1/02; A01B 1/06

(52) U.S. Cl. CPC A01B 1/02; A01B 1/06

(57) ABSTRACT

An elongated shaft to receive a working head of a garden implement. The elongated shaft comprises a terminal portion sized to receive the working head of the garden implement, and measuring indicia applied to the elongated shaft over at least a portion of the length of the elongated shaft.

### BACKGROUND

Garden implements are available in a wide variety of styles and designs. There is typically a garden implement available for every need. Some handheld garden implements are meant to be used while in a kneeling or seated position. These implements typically are used for planting small plants or when the gardening task calls for detailed work close to the ground. Many other handheld garden implements include an elongated shaft to be used while in an upright or standing position. These implements are typically used for tasks that require significantly more leverage, such as when edging grass, digging holes for fence posts or for planting larger plants or trees, and the like. Because gardening tasks vary, the number and type of garden implements required for a particular project could be significant. Many times, a gardener will have a handcart filled with garden implements in order to complete a single garden project.

Most often, planting beds and gardens are filled with a variety of trees and plants, with the goal of providing a colorful display of blooms and leaf variations, height and size differences, and the like. Accordingly, various plants and trees may be selected to complete a garden layout. Gardeners and landscapers typically select and install these plants and trees at very early stages of the plants' development. When purchased from a local garden center or from an online retailer, for example, these young plants and trees typically include care instructions for proper feeding, sun/shade needs, root ball depth, growing habits, height and width of the plant at full maturity, and the like, so that the plants or trees can achieve a healthy maturity. But in order to achieve this end, proper placement of the plants or trees such that they have sufficient room to grow and develop is an important part of landscape design. Failure to provide proper positioning and space for young plants and trees adversely affects garden aesthetics and plant health.

The foregoing discussion is intended only to illustrate some of the shortcomings present in the field of the invention at the time and should not be taken as a disavowal of claim scope.

### SUMMARY

In accordance with various embodiments of the present disclosure, there is provided a garden implement. Various embodiments of the garden implement comprise a working head and an elongated shaft extending from the working head. Measuring indicia is applied to the elongated shaft over at least a portion of the length of the elongated shaft.

In accordance with another embodiment, there is provided an elongated shaft to receive a working head of a garden implement. The elongated shaft comprises measuring indicia applied to the elongated shaft over at least a portion of the length of the elongated shaft.

In accordance with various embodiments of the present disclosure, there is provided a garden implement. Various embodiments of the garden implement comprise a working head, an elongated shaft extending from the working head, measuring indicia applied to at least a portion of the length of the elongated shaft, and an optional handle engaging the elongated shaft at an end opposite the working head. The measuring indicia accounts for the length of at least one of the working head and the optional handle.

Accordingly, various embodiments of the present disclosure provide solutions to many shortcomings associated with garden implements. Those of ordinary skill in the art will readily appreciate, however, that these and other details, features and advantages will become further apparent as the following detailed description of the embodiments proceeds.

### BRIEF DESCRIPTION OF THE DRAWINGS

The accompanying drawings, which are incorporated in and constitute a part of this specification, illustrate embodiments of the invention, and, together with the general description of the invention given above, and the detailed description of the embodiments given below, serve to explain the principles of the present disclosure.

FIG. 1 is a perspective view of one embodiment of the garden implement of the present disclosure;

FIG. 2 is a perspective view of another embodiment of the present disclosure;

FIG. 3a is a perspective view of a portion of an embodiment of the present disclosure, illustrating one form of the marking indicia;

FIG. 3b is a perspective view of a portion of a variation of the embodiment illustrated in FIG. 3a;

FIG. 4 is a perspective view of a portion of an embodiment of the present disclosure;

FIG. 5 is a perspective view of a portion of another embodiment of the present disclosure;

FIG. 6 is a perspective view of a portion of another embodiment of the present disclosure;

FIG. 7 is a perspective view of a portion of another embodiment of the present disclosure;

FIG. 8 is a side view of an embodiment of the present disclosure used to measure the distance between planted trees; and

FIG. 9 is a view of an embodiment of the present disclosure used to measure the depth of a hole.

### DETAILED DESCRIPTION

Certain exemplary embodiments will now be described to provide an overall understanding of the principles of the structure, function, manufacture, and use of the systems and components disclosed herein. One or more examples of these embodiments are illustrated in the accompanying drawings. Those of ordinary skill in the art will understand that the systems and components specifically described herein and illustrated in the accompanying drawings are non-limiting exemplary embodiments and that the scope of the various embodiments of the present disclosure is defined solely by the claims.

Reference throughout the specification to “various embodiments,” “some embodiments,” “one embodiment,” or “an embodiment”, or the like, means that a particular feature, structure, or characteristic described in connection with the embodiment is included in at least one embodiment. Thus, appearances of the phrases “in various embodiments,” “in some embodiments,” “in one embodiment”, or “in an embodiment”, or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation. Such modifications and variations are intended to be included within the scope of the present disclosure.

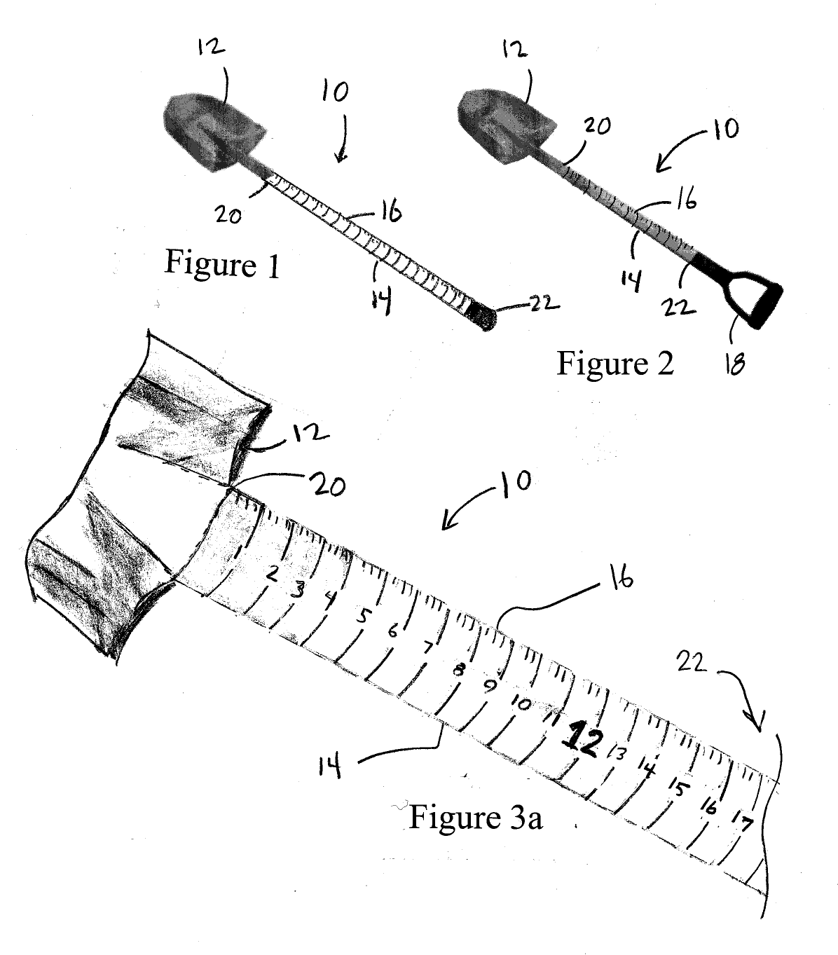

Referring now to the drawings for the purposes of illustrating embodiments of the invention only and not for the purpose of limiting the same, there is shown a garden implement, generally designated as 10. Various embodiments of the garden implement 10 are shown in FIGS. 1-9, illustrated in the form of a shovel. The embodiments disclosed in FIGS. 1-9 are provided for ease of description only and are not intended in any way to limit the scope of claims, as the garden implement 10 of the present disclosure can take the form of various garden implements as described herein. As can be seen in those Figures, various embodiments include a working head 12, an elongated shaft 14 extending from the working head 12, and measuring indicia 16 applied to the elongated shaft 14 over at least a portion of the length of the elongated shaft 14.

It is contemplated that any garden implement 10 may be employed in embodiments of the present disclosure, such as, for example, a shovel (illustrated), a spade, a hoe, a rake, a maddox (sometimes referred to as “mattock”), a pickaxe, a sledge hammer, a spading fork, a post hole digger, an edger, an axe, and a sickle. Generally, the garden implement 10 contemplated in embodiments of the present disclosure are those ground or soil-working handheld implements that have a relatively elongated shaft 14 and are employed when one is in a standing or substantially upright position, in certain embodiments using two hands, for leverage in digging holes or planting or positioning relatively larger plants and trees. The elongated shaft 14 may be suitably sized and formed of a material to allow for application of measuring indicia 16 thereon in order to display relatively long distances, as discussed in detail below.

The garden implement 10 may comprise any working head 12 configuration known to those of ordinarily skill in the art. As illustrated in FIG. 1, the working head 12 may be a shovel or spade-shaped head, for example, such as in embodiments where the garden implement 10 is a hoe, a spade, or a shovel. Other embodiments contemplated include a working head 12 that may comprise one or more tines, such as in embodiments where the garden implement 10 is a rake, a spading fork, and the like; a hammer head, such as in embodiments where the working head 12 is a sledge hammer and the like; or a bladed head, such as in embodiments where the garden implement is a maddox, an edger, a sickle, an axe, and the like. The working head 12 may be made of any suitable resilient material, such as metal, plastic, a composite, and combinations thereof. The working head 12 typically engages a terminal end of the elongated shaft 14 and is secured thereto by any suitable and secure method, such as by fastening the working head 12 to the elongated shaft 14. It is also contemplated that the working head 12 may be cast or otherwise formed together with the elongated shaft 14 such that the working head 12 and elongated shaft 14 are integrated as a single work piece.

The elongated shaft 14 may be any shape, length, or configuration known to those of ordinary skill in the art. For example, the elongated shaft 14 may have one or more flat surfaces with blunt edges, such as a four-sided shaft having a square or rectangular cross-section. In other embodiments, the elongated shaft 14 may have a cylindrical outer surface and circular or elliptical cross-section that may be desirable for a smooth and comfortable gripping surface. The elongated shaft 14 need not be a straight pole-shaped shaft, but in certain embodiments, the elongated shaft 14 may be a rod-shaped pole that extends along a single plane and has a substantially cylindrical outer surface. In certain embodiments, the elongated shaft 14 may be formed of a material selected from the group consisting of wood, metal, plastic, a composite, and combinations thereof. In certain embodiments, the elongated shaft 14 is a wooden shaft, such as is typically used with a shovel, maddox, hoe, and the like. In certain other embodiments, those of skill in the art may determine that metal shafts are particularly desirable, such as in situations where rigidity and strength are particularly preferred. In certain other embodiments, those of skill in the art may determine that composite materials, such as a plastic or carbide material, are particularly useful, such as in situations where some combination of strength and shaft flexibility is needed.

Referring again to FIG. 1, in certain embodiments, the elongated shaft 14 comprises two terminal ends, one end 20 to engage the working head 12 and the other end 22 that is opposite the working head 12 to be gripped by the user. The end 22 to be gripped by the user may be blunt or rounded so the user can comfortably operate and manipulate the garden implement 10. In certain other embodiments, such as illustrated in FIG. 2, the elongated shaft 14 may include a terminal end 22 to engage an optional handle 18. In either instance, the elongated shaft 14 may be any desired length to display the measuring indicia 16. In certain embodiments, in order for the elongated shaft 14 to be configured to measure appropriate depths or distances, it is contemplated that the elongated shaft 14 may be a length that displays measuring indicia 16 at a distance of at least one foot, two feet, three feet, four feet, five feet, or six feet in length, or any distance therebetween. In certain embodiments, it is contemplated that the elongated shaft 14 displays measuring indicia 16 of at least two feet, and in some embodiments, at least three feet in length. The measuring indicia 16 may include tick marks that display any desired unit of measure, such as U.S. customary units or the International System of Units (SI) (i.e., metric units). If U.S. customary units are employed, for example, typical units of measure may include inches, or fractions thereof, and feet. If metric units are employed, for example, typical units of measure include centimeters, or fractions thereof, and meters. Although the specific length and fractions of the measuring indicia 16 are not particularly important, in certain embodiments the length of the measuring indicia 16 may be of a suitable distance to accommodate larger gardening projects, such as measuring the depth of a relatively deep hole for fence posts or planting large plants or trees with large root balls, or for measuring the spacing distance between plants or trees.

The measuring indicia 16 may be applied to the elongated shaft 14 in any manner and at any desired length. For example, in certain embodiments, the measuring indicia 16 may be applied to the garden implement 10 along one side of the elongated shaft 14. In embodiments where the elongated shaft 14 is curved, the measuring indicia 16 may be applied to the elongated shaft 14 in a manner that follows the curvature of its outer surface. In other embodiments, the measuring indicia 16 may be applied to the garden implement 10 substantially entirely around the perimeter of the outer surface of the elongated shaft 14 and in embodiments where the elongated shaft 14 is rounded, substantially entirely around its circumference. In this latter configuration, because the measuring indicia 16 is applied in ring-like fashion around the perimeter of the elongated shaft 14, the user is able to read the measuring indicia 16 with ease without having to turn or rotate the elongated shaft 14. The measuring indicia 16 may be applied to the elongated shaft 14 over only a portion of its length or, in other embodiments, over substantially its entire length. The measuring indicia 16 may be applied to the garden implement 10 in any suitable manner that allows for viewing of the measuring indicia 16 on the elongated shaft 14. For example, all or at least a portion of the measuring indicia 16 may be applied to the surface of the elongated shaft 14 by at least one of brush coating, roll coating, spray coating, curtain coating, dip coating, spin coating, knife-edge coating, screen printing, flood coating, electrocoating, powder coating, and combinations of any thereof. In other embodiments, all or at least a portion of the measuring indicia 16 may be applied or recessed below the surface of the elongated shaft 14 by at least one of pressing, casting, searing, branding, cutting, scoring, notching, shaving, etching, and combinations of any thereof. In this embodiment, at least some tick marks of the recessed measuring indicia 16 may be filled with an inlaid material, such as wood, plastic, or a metal, to be flush or nearly flush with the outer surface of the elongated shaft 14. In other embodiments, all or a portion of the measuring indicia 16 may be applied to the elongated shaft 14 so that one or more tick marks are recessed below or protrude above the surface of the elongated shaft 14 in situations, for example, wherein the user may feel some or all of the indicia markings on the elongate shaft 14. For example, in certain embodiments it may be desirable for each half or whole foot marking measuring indicia 16 to protrude above the surface of the elongated shaft 14 while other measuring indicia 16 are applied at the surface level or below the surface of the elongated shaft 14. In this manner, the protrusions would allow the user to have, in a general sense, at least a rough idea of the actual distance being measured without the need to directly observe the measuring indicia 16. It is contemplated that various combinations of the application methods described herein may be employed together, wherein at least a portion of the measuring indicia 16 may be applied to the elongated shaft 14 by at least one of surface application, recess, inlay, protrusion, and the like, and combinations thereof, depending on the desires and needs of the user. It is contemplated that measuring indicia 16 recessed below the surface of elongated shaft 14 may be subject to less wear and last longer relative to surface applied measuring indicia 16. For example, if paint is applied to recessed grooves that comprise the measuring indicia 16, the recessed paint may provide clearer markings and last for a longer period of time due to less direct wear relative to paint markings that are applied directly to the surface of the elongated shaft 14. As an added benefit, recessed grooves may aid in gripping the elongated shaft 14 during working the garden implement 10.

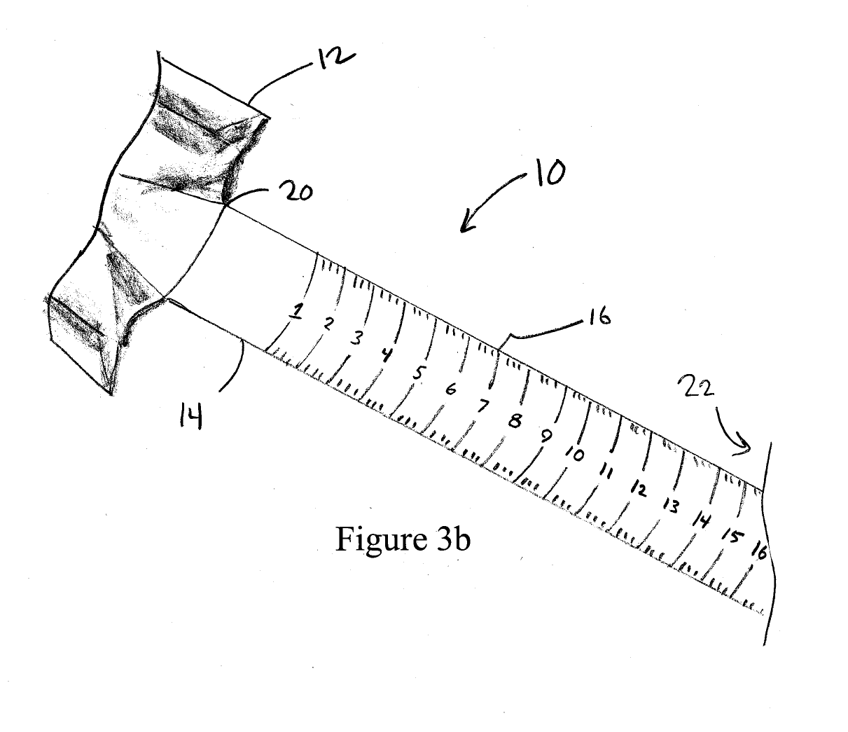

FIG. 3a illustrates an embodiment of the present disclosure wherein the measuring indicia 16 is applied to the elongated shaft 14 beginning directly at the terminal end 20 where the working head 12 engages the elongated shaft 14. As illustrated, in this embodiment, the measuring indicia 16 begins at distance 0 and counts up in quarter inch fractions toward the direction of the opposite end 22 of the elongated shaft 14. It is contemplated that in other embodiments, such as illustrated in FIG. 3b, the measuring indicia 16 may begin at distance 0 at some location along the elongated shaft 14 other than directly adjacent the working head 12. When the length of the working head 12 or optional handle 18 is not taken into account by the measuring indicia 16, in a practical sense, there is no need for the first tick mark of the measuring indicia 16 to be immediately adjacent to either the working head 12 or the optional handle 18. As illustrated, the measuring indicia 16 may begin at any distance from either terminal end 20, 22 of the elongated shaft 14. However, when the measuring indicia 16 is configured as illustrated in FIG. 3a, the working head 12 or the handle 18 may act as a visual guide at a distance 0 to aid in measuring depth or distance.

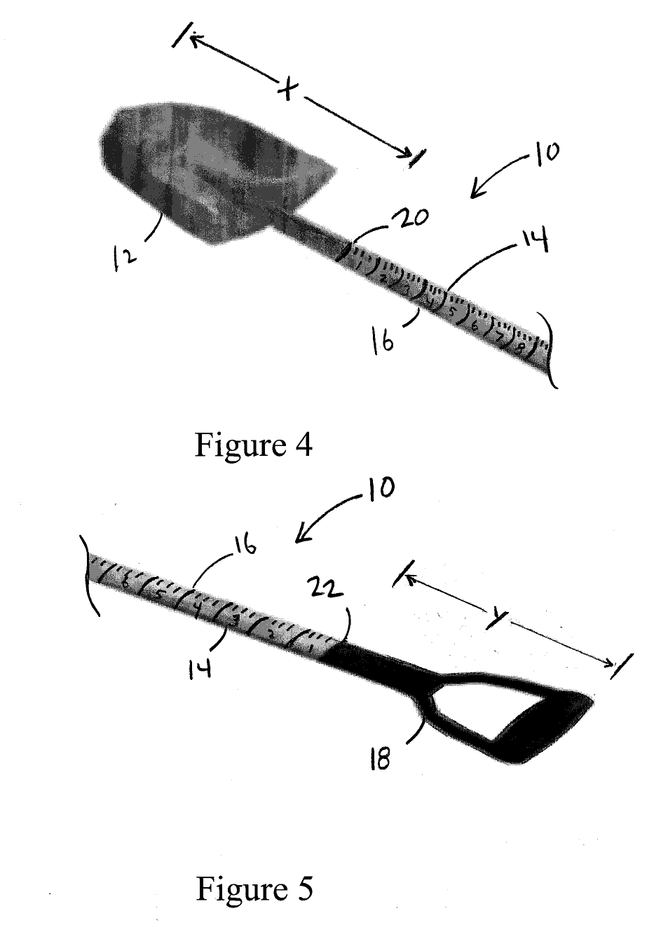

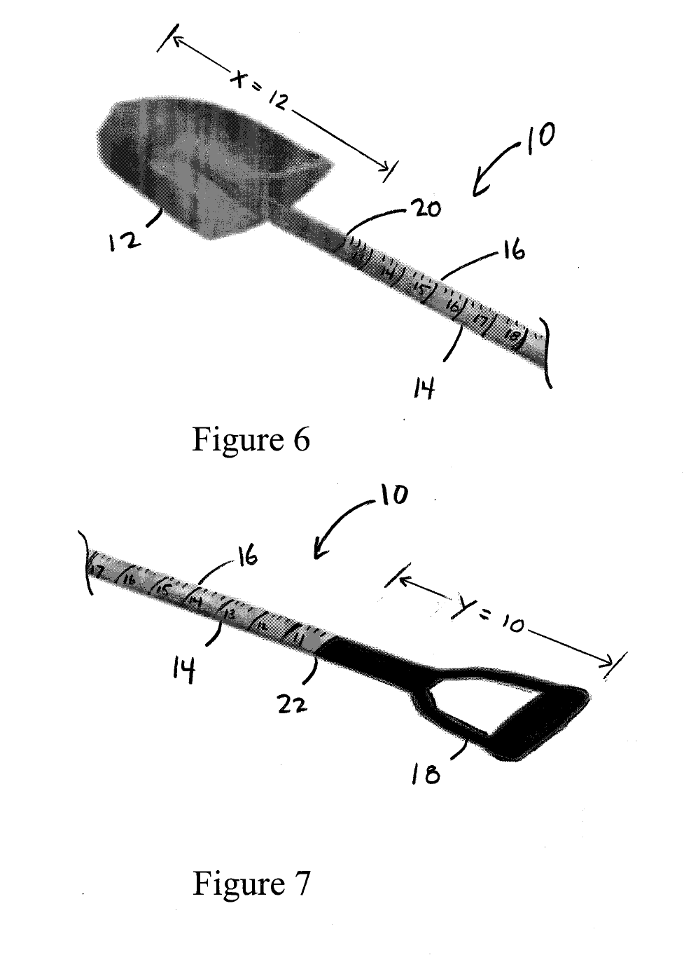

As discussed above, the first tick mark of the measuring indicia 16 may be applied at any desired location along the elongated shaft 14. For example, as illustrated in FIG. 4, the first tick mark of the measuring indicia 16 at distance 0 may be positioned adjacent the working head 12 at the terminal end 20 of the elongated shaft 14 and the remaining measuring indicia 16 may count up, for example, in quarter inch fractions and be applied to the elongated shaft 14 in a direction toward the area where the user typically grips the garden implement 10 (e.g., toward the optional handle 18). In another embodiment, illustrated in FIG. 5, the first tick mark of the measuring indicia 16 at distance 0 may be positioned adjacent to the terminal end 22 of the elongated shaft 14 where the user typically grips the garden implement 10 or adjacent handle 18, when present, and the remaining measuring indicia 16 may count up in, for example, quarter inch fractions and be applied to the elongated shaft 14 in a direction toward the working head 12. In another embodiment, illustrated in FIG. 6, the measuring indicia 16 may account for the length of the working head 12 such that the first tick mark of the measuring indicia 16 identified on the elongated shaft 14 adjacent to the working head 12 accounts for a distance from an outermost point of the working head 12 to the first tick mark. Accordingly, it is contemplated that the measuring indicia 16 may begin at 0 distance starting at either end of the elongated shaft 20, 22, or at a distance x or y that takes into account the length of the working head 12 (FIG. 6) or handle 18 (FIG. 7) that begins adjacent to where the working head 12 or handle 18 engages the elongated shaft 14. For example, as illustrated in FIG. 6, if the working head 12 is x inches in length where, for example, x=12 inches from its outermost point relative to the elongated shaft 14 to its attachment to the elongated shaft 14, the first tick mark adjacent the working head 12 on the elongated shaft 14 may take into account the length of the working head 12 and count up from 12 inches along the elongated shaft 14 toward the opposite end of the elongated shaft 14, toward the other terminal end 22 of the elongated shaft 22 or handle 18, when present. In like manner, where the garden implement 10 includes an optional handle 18 engaging the elongated shaft 14 at an end opposite the working head 12, the measuring indicia 16 may account for the length of the handle 18 such that a first tick mark of the measuring indicia 16 identified on the elongated shaft 14 adjacent to the handle 18 takes into account a distance from an outmost point of the handle 18 relative to the elongated shaft 14 to the first tick mark. For example, as illustrated in FIG. 7, if the handle 18 is y inches in length where, for example, y=10 inches from its outermost point to its attachment to the elongated shaft 14, the first tick mark adjacent the handle 18 on the elongated shaft 14 would take into account the length of the handle 18 and count up from 10 inches along the elongated shaft 14 toward the direction of the working head 12. In this manner, when the garden implement 10 is employed to measure, for example, the depth of a hole, the working head 12 or the handle 18 can be included in the overall measurement for convenience when, for example, the user places either end of the garden implement vertically down inside the hole to measure its depth. Or, where the distance between existing plants or trees is being measured, the user can employ the head or handle of the garden implement 10 as part of the distance measurement. In other embodiments, it is contemplated that two or more separate measuring indicia 16 may be provided on the elongated shaft 14, one that includes the length of one or both of the working head 12 and handle 18 (illustrated in FIG. 6 or 7, for example) and another measuring indicia 16 that does not (illustrated in FIG. 3, for example), so the user has the choice of using or not using the length of the working head 12 or handle 18 as part of the overall measurement. Accordingly, in certain embodiments, the measuring indicia 16 may begin at or near either terminal end 20, 22 of the elongated shaft 14 and may begin at distance 0, or at distance x that takes into account the length of the working head 12, from the tip of the working head to where it engages the elongated shaft 14, and/or at a distance y that takes into account the length of the handle 18, from the outermost end of the handle 18 to where it engages the elongated shaft 14. The two or more measuring indicia 16 may be applied as measuring strips along the elongated shaft 14, such as on opposite sides.

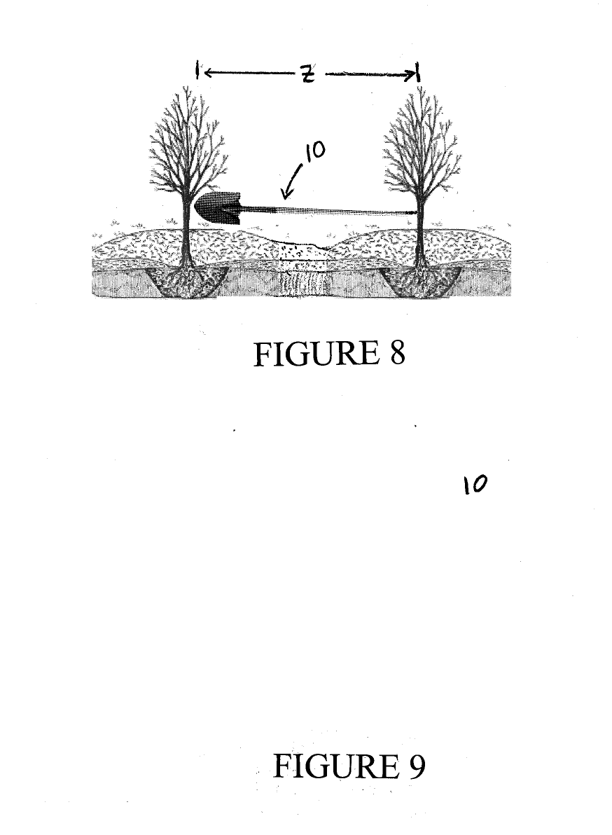

As illustrated in FIGS. 8 and 9, embodiments of the present disclosure may be used on site employing the garden implement 10 to plant trees or plants or simply to handle the measuring function of outside landscaping work for digging holes for various garden-related projects such as fence post installation, drainage ditch preparation and the like. In this manner, embodiments of the present disclosure allow for the accurate measurement of, for example, the distance z between trees or plants for proper placement, including, for example, the proper depth of a root ball (FIG. 8) or to accurately measure the depth of a hole, such as, for example, a drainage ditch (FIG. 9). Thus, plant or tree spacing is reproducible, accurate, and consistent if rows of plants or trees are desired or if certain spacing is required. Because planting beds and gardens are often filled with a variety of trees and plants with the goal of providing a colorful display of blooms and leaf variations, height and size differences, and the like, various hole depths and separation may be necessary. Typically, a gardener or landscaper carries a separate ruler, yardstick, or tape measure to assist in accurate and proper tree or plant placement. At certain other times, the gardener or landscaper may simply guess or estimate an appropriate depth or distance for the tree or plant because an accurate measuring device is not available, is forgotten, or misplaced. Because gardeners and landscapers typically select and install a plant or tree in a garden at a very early stage of its development, it is critical for the health of the tree or plant to be properly placed such that it has sufficient room to grow and develop. When purchased from a local garden center or from an online retailer, for example, these young plants and trees typically include care instructions for proper feeding, sun/shade needs, root ball depth, growing habits, height and width of the plant at full maturity, and the like, so that the plant or tree can achieve a healthy maturity. Failure to provide proper positioning and space for young plants and trees adversely affects garden aesthetics and plant health. Embodiments of the present disclosure help to address the need to accurately position the plant or tree or for other garden-type landscape projects that require proper hole depth or spacing by providing a garden implement 10 with measuring indicia 16 already applied thereon.

While several embodiments of the invention have been described, it should be apparent, however, that various modifications, alterations and adaptations to those embodiments may occur to persons skilled in the art with the attainment of some or all of the advantages of the invention. For example, according to various embodiments, a single component may be replaced by multiple components, and multiple components may be replaced by a single component, to perform a given function or functions. This application is therefore intended to cover all such modifications, alterations, and adaptations without departing from the scope and spirit of the disclosed invention as defined by the appended claims.

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The invention which is intended to be protected is not to be construed as limited to the particular embodiments disclosed. The embodiments are therefore to be regarded as illustrative rather than restrictive. Variations and changes may be made by others without departing from the spirit of the present disclosure. Accordingly, it is expressly intended that all such equivalents, variations, and changes which fall within the spirit and scope of the present disclosure as defined in the claims be embraced thereby.

What is claimed is:

1. A garden implement, comprising:
a working head;
an elongated shaft extending from the working head; and
measuring indicia applied to the elongated shaft over at least a portion of the length of the elongated shaft.

2. The garden implement of claim 1, wherein the garden implement is selected from the group consisting of a shovel, a spade, a hoe, a rake, a maddox, a pickaxe, a sledge hammer, a spading fork, a post hole digger, an edger, an axe, and a sickle.

3. The garden implement of claim 1, wherein the elongated shaft has a substantially cylindrical outer surface and the measuring indicia is applied to follow the curvature of the outer surface.

4. The garden implement of claim 3, wherein the measuring indicia is applied substantially entirely around the perimeter of the cylindrical outer surface of the elongated shaft.

5. The garden implement of claim 1, wherein the measuring indicia is applied to substantially the entire length of the elongated shaft.

6. The garden implement of claim 1, wherein at least a portion of the measuring indicia is applied to the elongated shaft by at least one of brush coating, roll coating, spray coating, curtain coating, dip coating, spin coating, knife-edge coating, screen printing, flood coating, electrocoating, powder coating, and combinations of any thereof.

7. The garden implement of claim 1, wherein at least a portion of the measuring indicia is applied to the elongated shaft by at least one of pressing, casting, searing, branding, cutting, scoring, notching, shaving, etching, and combinations of any thereof.

8. The garden implement of claim 1, wherein the measuring indicia is at least two feet in length.

9. The garden implement of claim 1, wherein a first tick mark of the measuring indicia at distance 0 is positioned adjacent a terminal end of the elongated shaft opposite the working head and the remaining measuring indicia counts up in a direction of the working head.

10. The garden implement of claim 1, wherein the measuring indicia accounts for the length of the working head.

11. The garden implement of claim 1, further comprising a handle that engages the elongated shaft at an end opposite the working head.

12. The garden implement of claim 11, wherein the measuring indicia accounts for the length of at least one of the working head and the handle.

13. The garden implement of claim 1, further comprising a handle and at least two separate measuring indicia on the elongated shaft, at least one of the measuring indicia accounting for the length of at least one of the working head and the handle.

14. An elongated shaft to receive a working head of a garden implement, comprising:
measuring indicia applied to the elongated shaft over at least a portion of the length of the elongated shaft.

15. The elongated shaft of the garden implement of claim 14, wherein the elongated shaft has a substantially cylindrical outer surface and the measuring indicia is applied to follow the curvature of the outer surface.

16. The elongated shaft of the garden implement of claim 14, wherein a first tick mark of the measuring indicia at distance 0 is applied at a terminal end of the elongated shaft opposite the working head, and the remaining measuring indicia counts up in the direction of the working head.

17. The elongated shaft of the garden implement of claim 14, wherein the measuring indicia accounts for the length of the working head.

18. The elongated shaft of the garden implement of claim 14, further comprising a handle engaging the elongated shaft at an end opposite the working head.

19. The garden implement of claim 18, wherein the measuring indicia accounts for the length of at least one of the working head and the handle.

20. A garden implement, comprising:
a working head;
an elongated shaft extending from the working head;
measuring indicia applied to at least a portion of the length of the elongated shaft, and
an optional handle engaging the elongated shaft at an end opposite the working head,
wherein a first tick mark of the measuring indicia identified on the elongated shaft immediately adjacent to at least one of the working head and the optional handle accounts for at least one of the length of the working head and the optional handle.
